(19) United States
(12) Patent Application Publication
(10) Pub. No.: US 2009/0217796 A1
(43) Pub. Date: Sep. 3, 2009

(54) Forearm wrap fretboard

(76) Inventor: Richard C. Rowley, Metairie, LA (US)

Correspondence Address: Richard C. Rowley, 418 North LaBarre Road, Metairie, LA, 70001, US

(21) Appl. No.: 12/074,203

(22) Filed: Mar. 3, 2008

(51) Int. Cl. G10D 3/00; A41D 20/00

(52) U.S. Cl. 84/315; 2/170

(57) ABSTRACT

A soft, removable forearm wrap worn on the user's forearm toward the wrist, which has “raised” artwork on it's exterior which faces away from it's user. This artwork has the appearance of part of a musical instrument fret board such as a guitar fret board (bass guitar, banjo, etc.) on it's exterior side (facing away from the user) and Velcro attachments on the inter side.

This invention can be fabricated using cloth; preferably a soft, sturdy fabric such as burlap, cotton, or elastic, etc. having the musical instrument fret board embedded via of embroidery, or a raised painted surface so that the person using this invention, can have a “feel of the strings”, etc. as the tips of their fingers touch the “raised” string graphics, and “squeezing” as if really playing.

Other material forming the “raised” fingerboard, such as plastic or wood, etc could accomplish the same “feel”.

Inside of this forearm wrap, (behind the fret board “raised” artwork) is a concealed pocket which would not only hold a ID, credit card, folded paper money, etc. but by adding one or two of these items would give the fret board a “better feel” as like having a “flat surface” to press their fingers on as they squeeze.

### BACKGROUND OF THE INVENTION

Over the years of teaching guitar, I have grabbed my right forearm with my left hand and proceeded to show other guitarist the correct way to finger a chord and/or chord progressions, etc. by using my forearm as an imaginary fret board.

This only gives them an idea of the finger position I'm trying to show, leaving the actual placement of each finger in relationship to the correct string and fret position to the imagination or memory of the student/person I'm showing this to.

I have also heard that some prisoners of war have learned to play using this same method.

Years ago, I was “pick-pocketed” and now I feel that having my ID/money in a forearm band, I can keep a better watch on it's whereabouts, since it would be in front of me inside this wrap, instead of behind me, in my back pocket.

### SUMMARY OF THE INVENTION

It is therefore an object of this invention to provide a forearm wrap which has a simulated mounted musical string instrument fret board such as a guitar, bass guitar, banjo, etc. where as a musician or someone wanting to practice fingering, chord positions, etc. can do so without disturbing others, or having to carry around a large musical instrument such as a guitar, banjo, etc.

Music instructors can use it as part of their teaching, eliminating some or most of the cumbersome task of picking up and putting down their instruments during their one-on-one student instructions, especially in a class setting where space can be at a minimum between students.

A “left-handed” style should also be produced by simply installing the hidden pocket upside down so that the pocket's content's would not “spill-out” as they remove this wrap giving “left-handed” people the opportunity to practice using this device.

The inside hidden pocket serves as a dual purpose of providing a “flat, hard fret board feel” and would also be useful as a way of carrying an ID and or credit cards, etc. as to a concert, jogging, etc.

### DESCRIPTION OF THE DRAWING

The description refers to the accompanying sketches in which like reference characters refer to like parts throughout the several views, and in which:

FIG. 1 is an Exterior view.

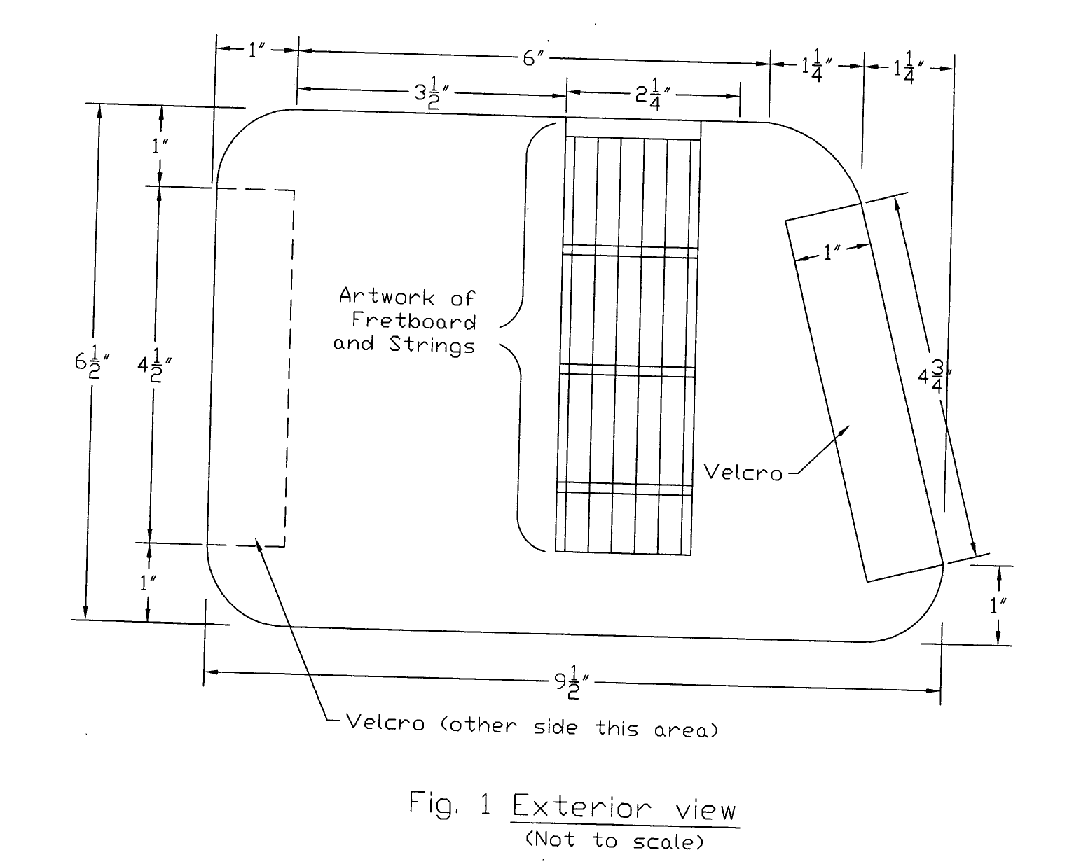

FIG. 2 is an Inside view.

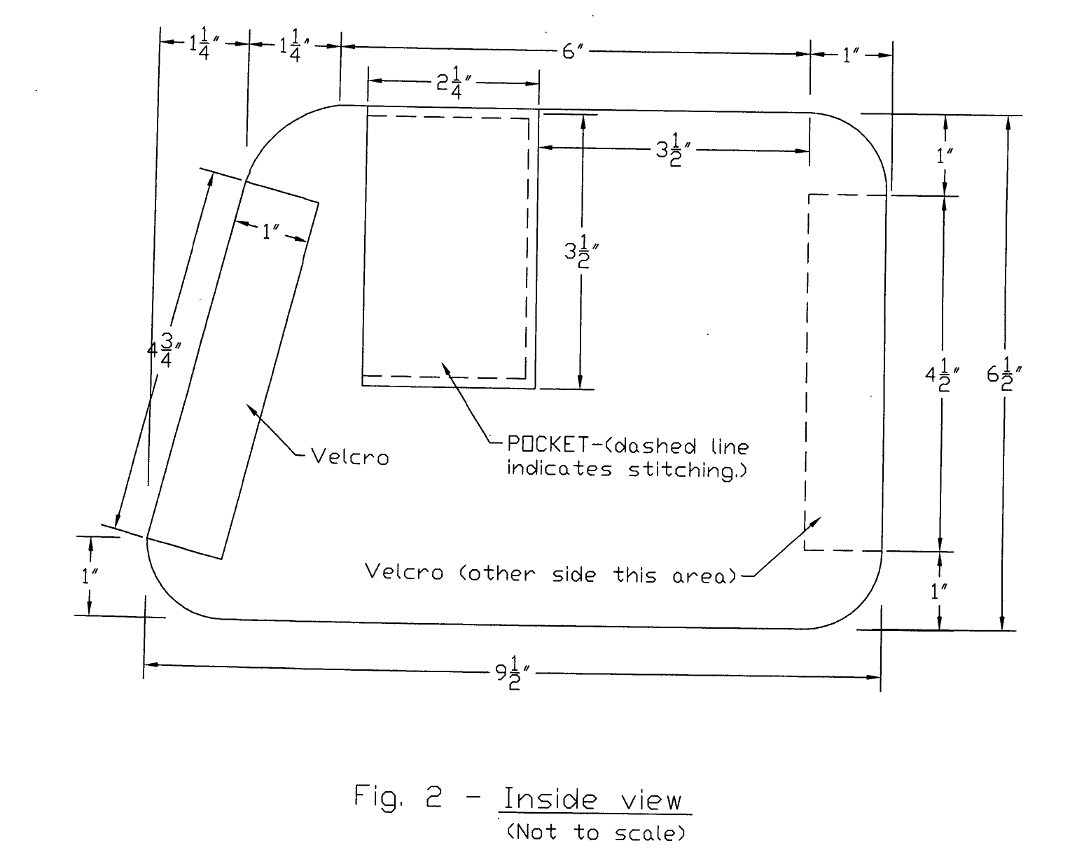

FIG. 3 is the Artwork of Fret board & Strings, which attaches to the exterior.

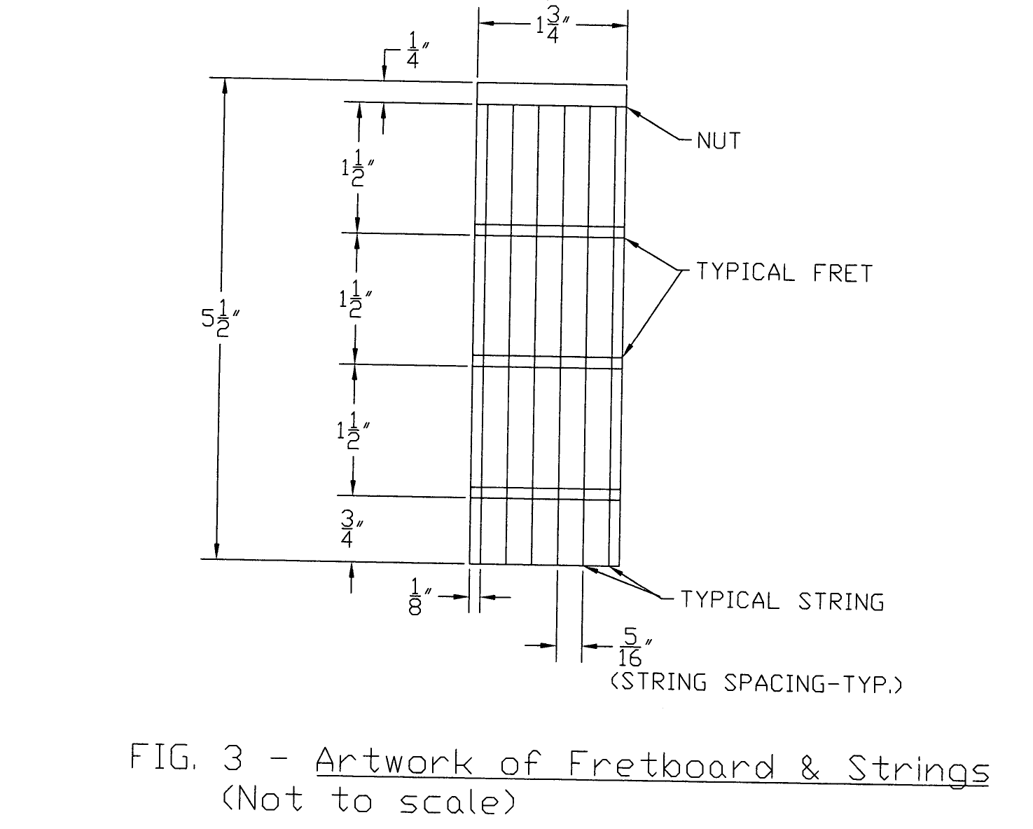

FIGS. 4, 5 and 6 Illustrated instructions showing how to wear and use this invention.

All dimensions shown are for the purpose of helping this reader understand the basic sizes needed for the construction of this invention.

In actual production, various styles, material, colors, etc. and dimensions may vary.

### DESCRIPTION OF THE PREFERRED EMBODIMENT

Referring to the drawing, a preferred forearm wrap decorated with a partial fret Board musical instrument fret board and having the “feel” of a fret board which also includes a hidden pocket.

Invention can be fabricated using cloth such as burlap, cotton, etc. and fret board design can be plastic, raised paint, ink or embroidered so that the person using it can have a “feel” of the strings.

Current U.S. Class: D3/215

Current International Class: 0301

Field of Search: D3/215,224,226,230 224/219,222,269,267 2/170 D28/64.1,64.2,64.3,64.4

U.S. Patent Documents

| | | |
|---|---|---|
| 5511702 | April 1996 | Yang |
| D371675 | July 1996 | Carter |
| D391075 | February 1998 | Jackson et al. |
| D438374 | March 2001 | Hayman |
| 6568574 | May 2003 | Jones et al. |
| D501990 | February 2005 | Carr |
| D507103 | July 2005 | Charles, Jr. |
| D515,805 | Feb. 28, 2006 | Jones |

Having described my invention, I claim:

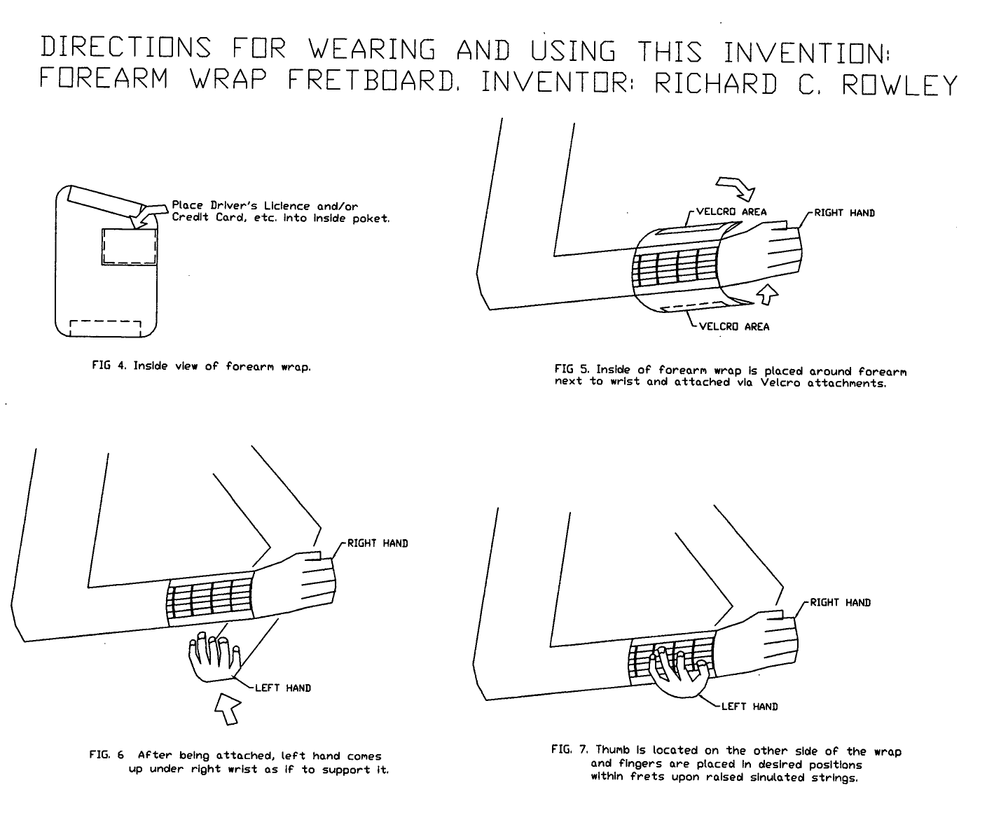

1. A forearm wrap, comprising:
of the appearance of a partial musical string instrument fret board (approx. 4½ frets in length) of a guitar, bass guitar, banjo, etc. in which the person wearing this device would be able to practice fingering and chord positions and also have a extra hidden pocket for caring an ID, credit cards, etc.
Operation of this invention (as shown in FIG. 4 thru FIG. 7) involves attaching it to their right forearm (next to the wrist) if “right-handed” via of Velcro attachments, and as the right arm moves toward the left side of the body, the left hand reaches under the right forearm and comes up to place fingers in position, as if playing a real fret board musical instrument.
If “left-handed”, the person would place it on their right wrist/arm and their right hand would perform the fingering positions.
